(19) United States
(12) Patent Application Publication
(10) Pub. No.: US 2005/0251848 A1
(43) Pub. Date: Nov. 10, 2005

(54) Multimedia message delivery optimisation

(75) Inventor: Omar Al-Janabi, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/965,265

(22) Filed: Oct. 15, 2004

(30) Foreign Application Priority Data
May 5, 2004 (GB) 0410014.5

(51) Int. Cl. H04N 7/173; H04N 7/16; G06F 13/00; H04N 5/445

(52) U.S. Cl. 725/135; 725/100; 725/61; 725/62

(57) ABSTRACT

A method provides multimedia messages to a plurality of subscribers. The method includes receiving a multimedia message for delivery to the plurality of subscribers. The method also includes converting the multimedia message into a plurality of formats. The method also includes providing multimedia message to ones of the plurality of subscribers in a format corresponding to a terminal format of the subscribers.

### BACKGROUND TO THE INVENTION

1. Field of the Invention

The present invention relates to multimedia messaging, and particularly but not exclusively to application-to-person mobile messaging.

2. Description of the Related Art

MMS (Multimedia Messaging Service) is a new service for person-to-person (P2P) and application-to-person (A2P) mobile messaging. It provides rich multimedia content, including images, audio, video, data and text. MMS is a globally standardized service and one of the 3G Partnership Project (3GPP) and Open Mobile Alliance (OMA) standardized services. MMS has emerged as a key technology. As well as enabling rich content to be created for messages, MMS also functions as a highly versatile platform for mobile applications and services.

Application-to-person (A2P) mobile messaging is defined as content that is generated on an application server and sent to mobile phones as a Multimedia Message. The content generated is usually based on a certain event or one or more pre-defined conditions. An example may be sending a video clip whenever a favourite soccer team scores a goal. Another example may be sending an alert whenever a stock price hits a certain threshold, or news breaks.

MMS application-to-person (A2P) is expected to grow at the same rate as SMS (Short Messaging Service), and is likely to represent a significant amount of the revenues generated in the MMS domain. MMS A2P is predicted to represent about 70% of total Multimedia Messaging service in the future.

The application-to-person type of Multimedia Messaging is for delivery of rich content to a mass number of subscribers. This delivery is usually necessary to be within a certain amount of time, otherwise the content of the message will lose its value. For example a stock price, soccer goal or even breaking news may become ‘old’.

Delivering a Multimedia Message usually requires content adaptation, as subscribers have different terminals. Multimedia Message content adaptation or transcoding is an essential feature to guarantee interoperability of the content with the receiving terminal, and usually has to be performed in real time, as the terminal capabilities are not known until the Multimedia Message is fetched. Content adaptation is therefore done in real time, and for every subscriber (mobile phone). This is very intensive, requiring a lot of processing power and causing delays in delivery.

In the art currently, techniques are used to attempt to resolve this conflict between the need to deliver messages quickly and the need to process messages before transmission. One technique is to create one single Multimedia Message with minimum content that is compatible with all possible mobile phones, and send that single message to all subscribers. The disadvantage with such technique is that the content is usually of poor quality, because of its need to be generic. Another technique is for the push Application or Application Server to create a Multimedia Message for each group of terminals that share the same level of capabilities. This requires the subscribers terminal type to be available, or to be provided by the subscriber, which may not always be possible. A still further technique is for content adaptation to be done for every single delivery (subscriber) at the time of the Multimedia Message fetch. The disadvantage with this technique is that the terminal capabilities are not known until the time of the Multimedia Message fetch.

It is an aim of the invention to provide an improved technique, which addresses one or more of the above-stated problems.

### SUMMARY OF THE INVENTION

According to one aspect of the invention there is provided a method of providing multimedia messages to a plurality of subscribers, comprising:
receiving a multimedia message for delivery to the plurality of subscribers; converting the multimedia message into a plurality of formats; and providing said multimedia message to ones of said plurality of subscribers in a format corresponding to a terminal format of said subscribers.

The step of receiving may include receiving said multimedia message at a multimedia message service centre or from an application server.

The step of receiving may include receiving said multimedia message from a push application.

The step of converting the multimedia message into a plurality of formats may include forwarding said multimedia message to a content adaptation engine from the multimedia message service centre.

The step of converting the multimedia message into a plurality of formats may include returning said plurality of formats of said multimedia message to the multimedia message service centre.

The plurality of formats may correspond to a plurality of terminal formats.

The plurality of formats preferably correspond to the plurality of multimedia content classes defined in the open media alliance multimedia message service conformance 1.2.

The plurality of formats may further include a default format, any of said plurality of terminals not being compliant with a multimedia content class being provided with the multimedia message in said default format.

The step of providing said multimedia message to ones of said plurality of subscribers may be responsive to receiving a message from said ones of said plurality of subscribers.

The message from said ones of said plurality of subscribers may be a fetch message to fetch the multimedia message.

The method may further comprise checking the terminal format of a subscriber on receipt of a message from a subscriber.

According to this aspect of the invention there is preferably provided a method of providing multimedia messages to a plurality of subscribers, comprising: receiving a multimedia message for delivery to the plurality of subscribers; converting the multimedia message into a plurality of formats corresponding to a plurality of multimedia content classes; and providing said multimedia message to ones of said plurality of subscribers in a format corresponding to a terminal format of said subscribers. Still preferably the multimedia content classes are those defined in the open media alliance multimedia message service conformance 1.2.

In a further aspect of the invention there is provided a network element for providing multimedia messages to a plurality of subscribers, comprising: a first input interface for receiving a multimedia message for delivery to the plurality of subscribers; a first output interface for forwarding the multimedia message to a content adaptation means; a second input interface for receiving the multimedia message in a plurality of formats from the content adaptation means; and a second output interface for forwarding said multimedia message to ones of said plurality of subscribers in the one of said plurality of formats corresponding to a terminal format of said subscribers.

The first output interface may be adapted to additionally forward to the content adaptation means a request to create a plurality of formats of the multimedia message.

The network element may further comprise a third input interface for receiving messages from ones of said plurality of subscribers, the second output interface being adapted to forward said multimedia message to ones of said plurality of subscribers responsive to receipt of a message from ones of said plurality of subscribers at said third input interface.

The network element may further include a memory for storing the multimedia message in the plurality of formats.

The network element may comprise a multimedia message service centre.

According to this further aspect of the invention there is preferably provided a network element for providing multimedia messages to a plurality of subscribers, comprising: a first input interface for receiving a multimedia message for delivery to the plurality of subscribers; a first output interface for forwarding the multimedia message to a content adaptation means; a second input interface for receiving the multimedia message in a plurality of formats corresponding to a plurality of multimedia content classes from the content adaptation means; and a second output interface for forwarding said multimedia message to ones of said plurality of subscribers in the one of said plurality of formats corresponding to a terminal format of said subscribers. Still preferably the multimedia content classes are those defined in the open media alliance multimedia message service conformance 1.2.

In a still further aspect of the invention there is provided a content adaptation engine comprising: an input interface adapted for receiving a multimedia message; a core engine for converting said multimedia message into a plurality of formats; and an output interface adapted to output said multimedia message in said plurality of formats.

The plurality of formats may include a plurality of multimedia content classes.

The plurality of multimedia content classes preferably include classes defined by the open mobile alliance multimedia message service conformance document 1.2.

The core engine may be adapted to convert said multimedia message into a plurality of formats responsive to receipt of an appropriate request at the first input interface.

The receipt of the multimedia message at the first input interface may constitute said appropriate request.

In this still further aspect of the invention there is preferably provided a content adaptation engine comprising: an input interface adapted for receiving a multimedia message; a core engine for converting said multimedia message into a plurality of formats corresponding to a plurality of multimedia content classes; and an output interface adapted to output said multimedia message in said plurality of formats. Still preferably the multimedia content classes are those defined in the open media alliance multimedia message service conformance 1.2.

In yet a further aspect the invention provides a multimedia messaging system comprising: a multimedia messaging service centre, MMSC, for receiving multimedia messages for delivery to a plurality of subscribers; and a content adaptation engine, CAE, converted to said MMSC, for converting multimedia messages into a plurality of formats wherein the MMSC is adapted to provide multimedia messages to said CAE, said CAE being responsive to said MMSC to convert said multimedia messages into all of said plurality of formats and to provide said plurality of formats of each multimedia message to the MMSC.

Said MMSC may be further adapted to store said plurality of formats of each multimedia message from the CAE.

Said MMSC may be further adapted to provide said multimedia message to ones of said plurality of subscribers in the format corresponding to a terminal format of said subscribers.

Said multimedia message may be provided to ones of said plurality of subscribers responsive to a fetch message from ones of said subscribers.

The multimedia messaging system may be adapted for application-to-person mobile messaging.

In this yet further aspect the invention preferably provides a multimedia messaging system comprising: a multimedia messaging service centre, MMSC, for receiving multimedia messages for delivery to a plurality of subscribers; and a content adaptation engine, CAE, converted to said MMSC, for converting multimedia messages into a plurality of formats corresponding to a plurality of multimedia content classes wherein the MMSC is adapted to provide multimedia messages to said CAE, said CAE being responsive to said MMSC to convert said multimedia messages into all of said plurality of formats and to provide said plurality of formats of each multimedia message to the MMSC. Still preferably the multimedia content classes are those defined in the open media alliance multimedia message service conformance 1.2.

Thus the invention utilises, in preferred embodiments, the concept of Multimedia Message Content Class (MM Content Class), defined in the OMA MMS Conformance Document 1.2, to enhance the mass delivery of Multimedia Messages in an application-to-person scenario.

Preferably multiple copies of the Multimedia Message are created, each of which conforms with a MM Content Class. These are stored at the MMSC. When a terminal fetches the Multimedia Message, the correct compatible message is provided immediately, with no extra processing or delays lost in content adaptation.

An example use case for embodiments of the invention is a service sending a Multimedia Message to registered subscribers whenever the English soccer team scores a goal in the world cup. If 10000 subscribers have registered for this service, 10000 best quality Multimedia Messages have to be delivered to those subscribers, who are likely to have different terminals (mobile phone) with different capabilities. Also, those messages have to be delivered in a very short period of time otherwise the message loses its value.

The invention is also applicable to mass delivery of Multimedia Messages in a person-to-person scenario, especially if the number of messages is significant. The invention is not limited to application-to-person scenarios.

### BRIEF DESCRIPTION OF THE FIGURES

FIG. 1 illustrates a multimedia messaging implementation in which embodiments of the invention may be supported; and

FIG. 2 illustrates the steps in multimedia messaging in a preferred embodiment of the invention.

### DESCRIPTION OF THE PREFERRED EMBODIMENTS

The invention is now described by way of reference to a particular preferable embodiment. In particular the invention is described in the context of an application-to-person mobile messaging scenario. The invention is not, however, limited to such a specific scenario.

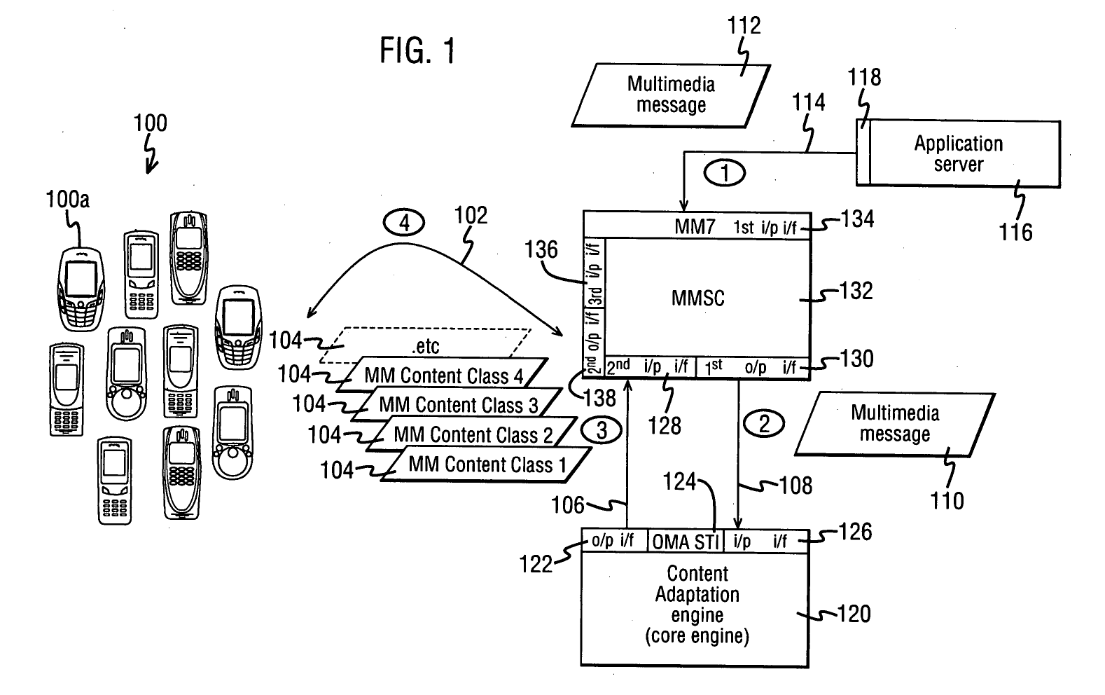

Referring to FIG. 1, there is illustrated typical functional elements of a multimedia messaging system. It will be appreciated by one skilled in the art that the implementation of a multimedia messaging system would require additional functionality to that shown in FIG. 1. In particular, in implementing a mobile multimedia messaging system the functionality of a wireless infrastructure is required. However the implementation of such a full system will be understood by one skilled in the art. Only those elements of a multimedia messaging system are shown in FIG. 1 as are necessary for understanding the embodiment of the invention. Any functional elements of a typical mobile multimedia messaging system not shown in FIG. 1 are not proposed to be modified by the invention, and may be implemented in accordance with known techniques.

As mentioned above, the embodiment relates to an application-to-person scenario. Referring to FIG. 1, the multimedia messaging system includes an application server 116, a multimedia message service centre (MMSC), and a content adaptation engine 120. The content adaptation engine 120, alternatively known as a transcoding/transformation engine, may comprise part of the MMSC 132. The actual implementation depends on the system architecture. In the described example it is assumed that the content adaptation engine 120 is an external system. The application server 116 has an interface 118, being an output interface. The MMSC 132 includes a first input interface 134, a second input interface 128, and a third input interface 136. Additionally the MMSC 132 includes a first output interface 130 and a second output interface 138. The content adaptation engine 120 includes an input interface 126, an output interface 122, and an OMA STI 124.

Also shown in FIG. 1 is a plurality of mobile phones or user equipment 100, such as mobile phone 100a. In an application-to-person scenario, the plurality of mobile phones 100 represent a plurality of mobile terminals to which a particular multimedia message is to be transmitted or broadcast. In this embodiment the application server 116 may be any application, such as a server which supports the transmission of user information, sports updates, or financial news information for example. The plurality of user terminals 100 may be associated with users who are subscribers to the services provided by the application server 116. The invention is generally not limited to the provision of an application server. The multimedia message for delivery to a plurality of terminals may be provided, for example, by a push application in an alternative arrangement.

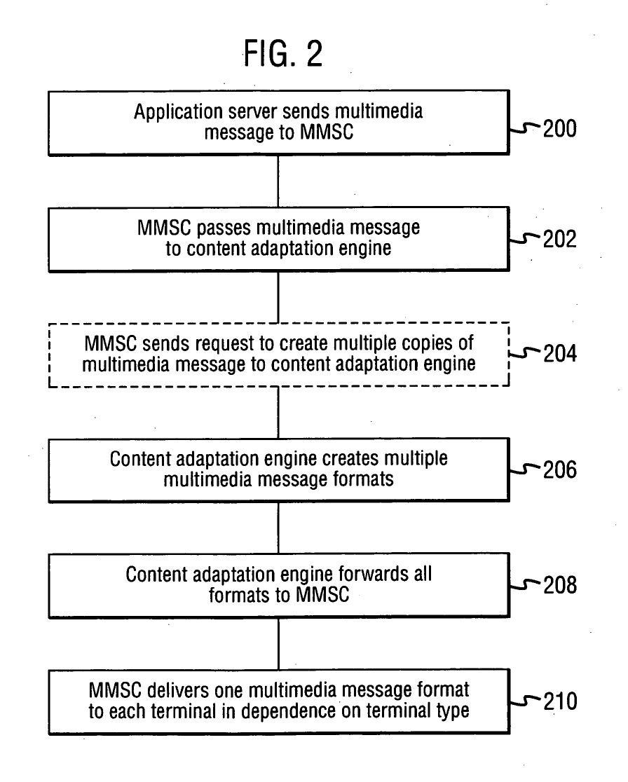

The embodiment is now described further with reference to the flowchart of FIG. 2, and further reference to the implementation of FIG. 1.

In a first step 200, the application server 116 sends a multimedia message to the MMSC 132. The sending of the multimedia message from the application server 116 may be triggered by a particular event. Referring to FIG. 1, the multimedia message is sent from the interface 118 of the application server 116 to the first input interface of the MMSC 132 via a signal line 114. The transmission of the multimedia message on signal line 114 is represented by block 112. In a preferred embodiment, the first input interface 134 is a MM7 interface.

As denoted by step 202, on receipt of the multimedia message from the application server the MMSC 132 passes the multimedia message to the content adaptation engine 120. The multimedia message, as represented by block 110, is transmitted from the first output interface 130 of the MMSC 132 to the input interface 126 of the content adaptation engine 120 via signal line 108.

As denoted by step 204, the MMSC 132 may additionally send a request to the content adaptation engine 120, via the interfaces 130 and 126, to instruct the content adaptation engine to create multiple copies of the multimedia message, each copy corresponding to a different possible format.

In a preferred embodiment each copy corresponds to a message content class as defined in the OMA Conformance Document 1.2. In OMA Conformance Document 1.2 for MMS mass delivery there are currently five message classes defined, corresponding to the types: text; image basic; image rich; video basic; and video rich.

Whilst in FIG. 2 step 204 represents a distinct transmission of a request to create multiple copies, in embodiments no specific request may be required, and the transmission of the request in step 204 may be optional. The request to create multiple copies of the multimedia message may be contained in the transmission of the multimedia message itself from the MMSC 132 to the content adaptation engine 120.

Responsive to the request to create multiple copies (i.e. multiple formats) of the multimedia message, whether such request is inherent in the receipt of the multimedia message itself or transmitted specifically, the content adaptation engine 120 carries out the generation of such copies or formats. Preferably, the content adaptation engine 120 carries out the generation of such copies or formats. Preferably, the content adaptation engine creates a plurality of formats of the multimedia message corresponding to all possible formats of mobile terminals. In a preferred embodiment, the content adaptation engine 120 at least creates a multimedia message for each multimedia content class defined in the open mobile alliance (OMA) multimedia message service Conformance 1.2. However, it would be understood by one skilled in the art that the content adaptation engine may be adapted to generate any appropriate format of the multimedia message, to ensure that a format is generated for each possible terminal type which may receive the message. The generation of such types of message using a content adaptation engine is known in the art.

Once the plurality of multimedia message types is generated, the content adaptation engine 120 returns all such copies to the MMSC 132. The copies are returned by the output interface 122 on signal line 106 to the second input interface 128 of the MMSC 132. The blocks 104 represent the plurality of types of multimedia message generated. In the embodiment, the plurality of types are MM content classes. MM content classes 1 to 4 are illustrated by way of example in FIG. 1

The forwarding of the multiple multimedia message formats is represented by step 206.

Thereafter, the multimedia messages, being copies of the multimedia message corresponding to the various types of user terminal, are stored in the MMSC 132.

As is known in the art, in order to deliver a multimedia message the MMSC sends an MMS notification to each subscribed terminals to inform the terminal of the new message. Responsive to this notification, each terminal initiates a fetch request message to the MMSC. The MMSC 132 then receives the fetch messages from various ones of the mobile terminals 100 on signal line 102 at the third input interface 136. Responsive thereto, the MMSC 132 returns the appropriate multimedia message format via the second output interface 138 of the MMSC 132 on the signal line 102 to the particular mobile terminal. The selected multimedia message type will correspond to the terminal type making the fetch request. This is represented by step 210. In the preferred embodiment the appropriate one of the message class types is returned.

In the preferred embodiment, where the content adaptation engine 120 is adapted to generate types of the multimedia message corresponding to the OMA MMS conformance document 1.2, it may be possible that the multimedia message needs to be delivered to terminal types which are not compliant with such standard. As such, in an embodiment a manual list of the most common terminal types may be additionally created, and each terminal type given a certain MM content class. In a further alternative, a default multimedia message type may be defined, being one of the types of multimedia message generated by the content adaptation engine. When the MMSC 132 receives a fetch from a terminal and can find no MM content class match, then the default multimedia message type may simply be forwarded to that terminal.

The invention, and embodiments thereof, offers several significant advantages over the prior art. The invention speeds up the mass delivery of application-to-person multimedia messages. No extra processing is required in real time, the content adaptation not being carried out in real time. The invention significantly minimises the number of requests made to the content adaptation engine, a single request being necessary to ensure all possible formats are generated. The total processing power required by the multimedia messaging system to deliver all of the messages is reduced. The invention, and embodiments thereof, enhance the end-user experience, the best quality content in the shortest possible delivery time being obtained, plus the best compatibility with the user's terminal (typically mobile phone). As a result, the implementation of embodiments of the invention may speed up the deployment of application-to-person implementations by network operators and content providers. There is no requirement to know a subscriber terminal type before operation, nor to require multiple variants of the message for different terminal (mobile phone) types.

The invention has particular advantage in any scenario where a multimedia message is to be sent to more than one mobile terminal. However as will be apparent from the above, the invention will be especially advantageous where the multimedia message is to be sent to a very large number of mobile terminals.

The content adaptation engine 120 carries out transcoding or transformation and manipulation of content as is known in the art. This content may be image contents, audio contents, video contents, or mark-up contents. The manipulation of the content, or transformation of such, is to suit the desired terminal capabilities or specifications.

The invention has been described hereinabove in relation to a particular exemplary embodiment, and particularly in relation to an application-to-person scenario. The invention is not limited to any specific elements of the described embodiment. The invention may be more generally applicable. The scope of the invention is defined by the appended claims.

1. A method of providing multimedia messages to a plurality of subscribers, comprising:
receiving a multimedia message for delivery to a plurality of subscribers;
converting the multimedia message into a plurality of formats; and
providing said multimedia message to ones of said plurality of subscribers in a format corresponding to a terminal format of said plurality of subscribers.

2. A method according to claim 1, wherein the step of receiving includes receiving said multimedia message at a multimedia message service centre.

3. A method according to claim 1, wherein the step of receiving includes receiving said multimedia message from an application server.

4. A method according to claim 1, wherein the step of receiving includes receiving said multimedia message from a push application.

5. A method according to claim 2, wherein the step of converting the multimedia message into the plurality of formats includes forwarding said multimedia message to a content adaptation engine from the multimedia message service centre.

6. A method according to claim 5, wherein the step of converting the multimedia message into the plurality of formats includes returning said plurality of formats of said multimedia message to the multimedia message service centre.

7. A method according to claim 1, wherein the step of converting the multimedia message into the plurality of formats includes corresponding the plurality of formats to a plurality of terminal formats.

8. A method according to claim 1, wherein the step of converting the multimedia message into the plurality of formats includes corresponding the plurality of formats to a plurality of multimedia content classes defined in an open media alliance multimedia message service conformance 1.2.

9. A method according to claim 8, wherein the plurality of formats further include a default format, wherein any of said plurality of terminal formats not being compliant with a multimedia content class are provided with the multimedia message in said default format.

10. A method according to claim 1, wherein the step of providing said multimedia message to ones of said plurality of subscribers is responsive to receiving a message from said ones of said plurality of subscribers.

11. A method according to claim 10, wherein the message from said ones of said plurality of subscribers comprises a fetch message to fetch the multimedia message.

12. A method according to claim 10, further comprising checking the terminal format of a subscriber on receipt of a message from the subscriber.

13. A network element for providing multimedia messages to a plurality of subscribers, the network element comprising:
a first input interface for receiving a multimedia message for delivery to a plurality of subscribers;
a first output interface for forwarding the multimedia message to a content adaptation means;
a second input interface for receiving the multimedia message in a plurality of formats from the content adaptation means; and
a second output interface for forwarding said multimedia message to ones of said plurality of subscribers in one of said plurality of formats corresponding to a terminal format of said plurality of subscribers.

14. A network element according to claim 13, wherein the first output interface is configured to additionally forward to the content adaptation means a request to create a plurality of formats of the multimedia message.

15. A network element according to claim 13, further comprising a third input interface for receiving messages from said ones of said plurality of subscribers, the second output interface configured to forward said multimedia message to said ones of said plurality of subscribers responsive to receipt of a message from said ones of said plurality of subscribers at said third input interface.

16. A network element according to claim 13, further including a memory for storing the multimedia message in the plurality of formats.

17. A network element according to claim 13, comprising a multimedia message service centre.

18. A content adaptation engine comprising:
an input interface configured for receiving a multimedia message;
a core engine for converting said multimedia message into a plurality of formats; and
an output interface configured to output said multimedia message in said plurality of formats.

19. A content adaptation engine according to claim 18, wherein the plurality of formats include a plurality of multimedia content classes.

20. A content adaptation engine according to claim 19, wherein the plurality of multimedia content classes include classes defined by an open mobile alliance multimedia message service conformance document 1.2.

21. A content adaptation engine according to any claim 18, wherein the core engine is configured to convert said multimedia message into the plurality of formats responsive to receipt of an appropriate request at the input interface.

22. A content adaptation engine according to claim 21, wherein the receipt of the multimedia message at the input interface constitutes said appropriate request.

23. A multimedia messaging system comprising:
a multimedia messaging service centre (MMSC) for receiving multimedia messages for delivery to a plurality of subscribers; and
a content adaptation engine (CAE) converted to said MMSC, for converting multimedia messages into a plurality of formats wherein the MMSC is configured to provide the multimedia messages to said CAE, said CAE responsive to said MMSC to convert said multimedia messages into all of said plurality of formats and to provide said plurality of formats of each multimedia message to the MMSC.

24. A multimedia messaging system according to claim 23, wherein said MMSC is further configured to store said plurality of formats of each multimedia message from the CAE.

25. A multimedia messaging system according to claim 23, wherein said MMSC is further configured to provide said multimedia message to ones of said plurality of subscribers in a format corresponding to a terminal format of said plurality of subscribers.

26. A multimedia messaging system according to claim 25, wherein said multimedia message is provided to the ones of said plurality of subscribers responsive to a fetch message from the ones of said plurality of subscribers.

27. A multimedia messaging system according to claim 23, wherein the multimedia messaging system is configured for application-to-person mobile messaging.

28. A system for providing multimedia messages, the system comprising:
receiving means for receiving a multimedia message for delivery to a plurality of subscribers;
converting means for converting the multimedia message into a plurality of formats; and
providing means for providing means for providing said multimedia message to ones of said plurality of subscribers in a format corresponding to a terminal format of said plurality of subscribers.
